(19) United States
(12) Patent Application Publication
(10) Pub. No.: US 2025/0141666 A1
(43) Pub. Date: May 1, 2025

(54) SYSTEM AND METHOD FOR ENCRYPTED DISK INSPECTION

(71) Applicant: Wiz, Inc., New York, NY (US)

(72) Inventors: Yaniv SHAKED, Tel Aviv (IL); Eyal MOSCOVICI, Tel Aviv (IL)

(73) Assignee: Wiz, Inc., New York, NY (US)

(21) Appl. No.: 19/003,846

(22) Filed: Dec. 27, 2024

Related U.S. Application Data
(63) Continuation of application No. 18/146,074, filed on Dec. 23, 2022.
(60) Provisional application No. 63/266,031, filed on Dec. 27, 2021.

(51) Int. Cl. H04L 9/08; H04L 67/1097

(52) U.S. Cl. CPC H04L 9/0825; H04L 9/0822; H04L 67/1097

(57) ABSTRACT

A system and method for inspecting encrypted disks for a cybersecurity object using a custom key is presented. The method includes detecting an encrypted disk associated with a workload in a cloud computing environment, the cloud computing environment including a security policy server; authorizing a key policy for decrypting the encrypted disk on the security policy server for a custom key associated with an inspector account; decrypting the encrypted disk with the custom key by the inspector account; and generating an inspectable disk based on the decrypted encrypted disk.

### CROSS-REFERENCE TO RELATED APPLICATIONS

This application is a continuation of U.S. Non-Provisional application Ser. No. 18/146,074, filed Dec. 23, 2022, which itself claims the benefit of U.S. Provisional Application No. 63/266,031 filed on Dec. 27, 2021, the contents of which are hereby incorporated by reference.

### TECHNICAL FIELD

The present disclosure relates generally to cybersecurity threat detection, specifically to inspection of encrypted disks during threat detection.

### BACKGROUND

Cybersecurity threats are ever present in cloud computing environments and often leave traces, indicators, and the like, on a disk, storage space, memory, etc., of the workload with which they are associated. For example, a cybersecurity threat can be a misconfiguration, a vulnerability, an exposure, a weak secret, an exposed password, an out of date software application, and the like.

Scanning for cybersecurity threats in a cloud computing environment often includes scanning storage, disks, and the like, for such cybersecurity objects. One method of protecting information includes encrypting storage resources, such as disks, so that even if they are accessed by an unauthorized party, the disk is not readable. However, such encrypted disks also cannot be scanned as a scanner requires an unencrypted volume to access. Encrypted disks present a challenge as decryption keys may not be readily available, and therefore their contents cannot be scanned.

Encryption of disks can be performed at application level, on a cloud platform level, or both. A scanner therefore cannot readily access the information on the disk, or determine what it present on it.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for inspecting encrypted disks for a cybersecurity object using a custom key. The method comprises: detecting an encrypted disk associated with a workload in a cloud computing environment, the cloud computing environment including a security policy server; authorizing a key policy on the security policy server for a custom key of an inspector account, where the key policy is a policy authorized to decrypt the encrypted disk; decrypting the encrypted disk with the custom key, where the key policy is configured to allow adding a custom key. The method also includes generating an inspectable disk based on the decrypted encrypted disk.

Certain embodiments disclosed herein also include a non-transitory computer-readable medium having stored thereon causing a processing circuitry to execute a process, the process comprising: detecting an encrypted disk associated with a workload in a cloud computing environment, the cloud computing environment including a security policy server; authorizing a key policy on the security policy server for a custom key of an inspector account, where the key policy is a policy authorized to decrypt the encrypted disk; decrypting the encrypted disk with the custom key, where the key policy is configured to allow adding a custom key. The medium also includes generating an inspectable disk based on the decrypted encrypted disk.

Certain embodiments disclosed herein also include a system for inspecting encrypted disks for a cybersecurity object using a custom key. The system comprises: a processing circuitry; and a memory, the memory containing instructions that, when executed by the processing circuitry, configure the system to: detect an encrypted disk associated with a workload in a cloud computing environment, the cloud computing environment including a security policy server; authorize a key policy on the security policy server for a custom key of an inspector account, where the key policy is a policy authorized to decrypt the encrypted disk; decrypt the encrypted disk with the custom key, where the key policy is configured to allow adding a custom key. The system also generates an inspectable disk based on the decrypted encrypted disk.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include detecting an encrypted disk associated with a workload in a cloud computing environment, the cloud computing environment including a security policy server. The method may also include authorizing a key policy for decrypting the encrypted disk on the security policy server for a custom key associated with an inspector account. The method may furthermore include decrypting the encrypted disk with the custom key by the inspector account; and generating an inspectable disk based on the decrypted encrypted disk. Other embodiments of this aspect include corresponding computer systems, apparatus, and computer programs recorded on one or more computer storage devices, each configured to perform the actions of the methods.

Implementations may include one or more of the following features. The method may include: inspecting the inspectable disk to detect a cybersecurity object. The method may include: generating the inspectable disk based on a clone of the decrypted encrypted disk. The method may include: generating the inspectable disk based on a snapshot of the decrypted encrypted disk. The method may include: generating the inspectable disk based on a copy of the decrypted encrypted disk. The method may include: determining that the encrypted disk utilizes an application based encryption; and fetching the custom key from a key vault management system. The method may include: decrypting the custom key, where the custom key is encrypted using a key-encryption-key. The method may include: setting a decoded base64 key from a key vault on the encrypted disk, in response to determining that an operating system of the workload utilizes Bitlocker. The method may include: determining that the encrypted disk is encrypted based on metadata associated with the encrypted disk. Implementations of the described techniques may include hardware, a method or process, or a computer tangible medium.

In one general aspect, a non-transitory computer-readable medium may include one or more instructions that, when executed by one or more processing circuitries of a device, cause the device to: detect an encrypted disk associated with a workload in a cloud computing environment, the cloud computing environment including a security policy server; authorize a key policy for decrypting the encrypted disk on the security policy server for a custom key associated with an inspector account; decrypt the encrypted disk with the custom key by the inspector account; and generate an inspectable disk based on the decrypted encrypted disk. Other embodiments of this aspect include corresponding computer systems, apparatus, and computer programs recorded on one or more computer storage devices, each configured to perform the actions of the methods.

In one general aspect, a system may include one or more processing circuitries configured to: detect an encrypted disk associated with a workload in a cloud computing environment, the cloud computing environment including a security policy server. The system may furthermore authorize a key policy for decrypting the encrypted disk on the security policy server for a custom key associated with an inspector account. The system may in addition decrypt the encrypted disk with the custom key by the inspector account. The system may moreover generate an inspectable disk based on the decrypted encrypted disk. Other embodiments of this aspect include corresponding computer systems, apparatus, and computer programs recorded on one or more computer storage devices, each configured to perform the actions of the methods.

Implementations may include one or more of the following features. A system where the one or more processing circuitries are further configured to: inspect the inspectable disk to detect a cybersecurity object. The system where the one or more processing circuitries are further configured to: generate the inspectable disk based on a clone of the decrypted encrypted disk. The system where the one or more processing circuitries are further configured to: generate the inspectable disk based on a snapshot of the decrypted encrypted disk. The system where the one or more processing circuitries are further configured to: generate the inspectable disk based on a copy of the decrypted encrypted disk. The system where the one or more processing circuitries are further configured to: determine that the encrypted disk utilizes an application based encryption; and fetch the custom key from a key vault management system. The system where the one or more processing circuitries are further configured to: decrypt the custom key, where the custom key is encrypted using a key-encryption-key. The system where the one or more processing circuitries are further configured to: set a decoded base64 key from a key vault on the encrypted disk, in response to determining that an operating system of the workload utilizes Bitlocker. The system where the one or more processing circuitries are further configured to: determine that the encrypted disk is encrypted based on metadata associated with the encrypted disk. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a network diagram of a production cloud environment and an inspecting cloud environment, implemented in accordance with an embodiment.

FIG. 2 is a flowchart of a method for inspecting encrypted disks of workloads in a cloud environment, implemented according to an embodiment.

FIG. 3 is a flowchart of a method for disk decryption utilizing a custom key for security risk inspection, implemented in accordance with an embodiment.

FIG. 4 is a flowchart of a method for disk decryption utilizing a default key for security risk inspection, implemented in accordance with an embodiment.

FIG. 5 is a schematic diagram of a system configured to execute an inspector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for inspecting encrypted storage, and specifically encrypted disks, for cybersecurity risks. Encryption in cloud computing environments can occur at a cloud-level, application level, combinations thereof, and the like. Some encryption schemes further utilize key encryption keys, adding a further layer of encryption when attempting to access a disk for inspection purposes.

It is advantageous to provide cybersecurity inspectors with access to encrypted disks as this allows inspection of otherwise inaccessible storage resource. Furthermore, by decrypting a disk for an inspector, a single inspector can be configured to inspect multiple decrypted disks, thus reducing a need to engineer an inspector workload for each encrypted disk, as disks can be encrypted on at least two levels, and are further complicated by utilizing different cloud computing environments, different operating system-level encryptions, and the like.

A system and method for inspecting encrypted disks includes an inspection cloud environment which detects encrypted disks in a production computing environment. According to an embodiment, an encrypted disk needs to be decrypted in order to inspect the encrypted disk for a cybersecurity risk. In an embodiment, an inspector account (e.g., user account, service account, and the like) deployed in the production computing environment is configured to generate an inspectable disk based on the encrypted disk utilizing decryption, based on the type of encryption. For example, an encryption type is application-based, cloud-based, and the like, according to an embodiment. In some embodiments encryption utilizes custom keys, default encryption keys, and the like.

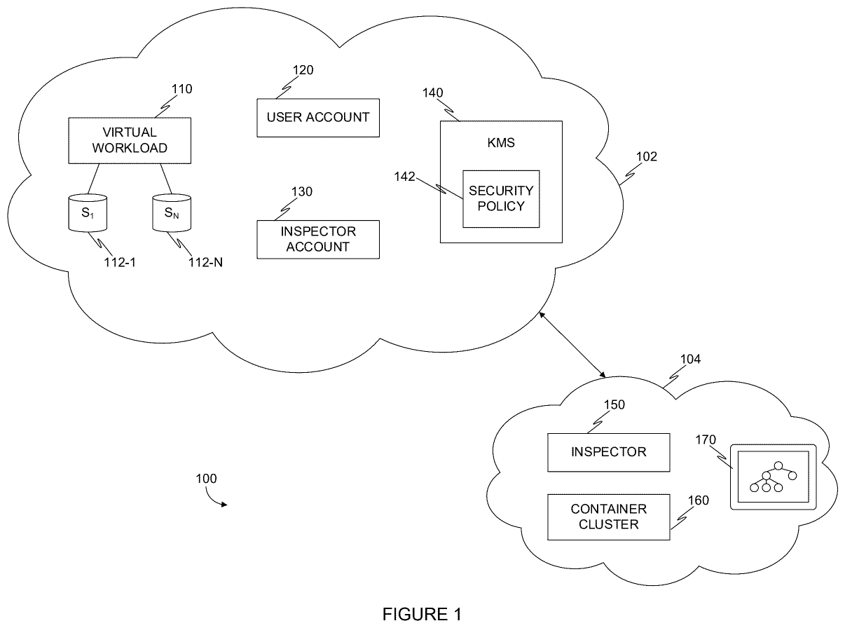

FIG. 1 is an example schematic illustration of a network diagram 100 of a production cloud environment and an inspecting cloud environment, utilized to describe an embodiment. In an embodiment, a production cloud environment 102 includes a plurality of principals, such as user account 120, and a plurality of virtual resources, such as virtual workload 110. In some embodiments, a cloud environment is implemented utilizing a cloud computing infrastructure, such as Amazon® Web Services (AWS), Microsoft® Azure, or Google® Cloud Platform (GCP). Storage may be implemented, for example using S3 in AWS.

In an embodiment, a virtual resource is a cloud entity which provides a service, access to a service, provisioning of hardware, and the like, such as a virtual machine, a software container, a serverless function, and the like. In certain embodiments, a principal is a cloud entity which is authorized to act on a resource. For example, according to an embodiment, a principal is a user account, a service account, a role, a combination thereof, and the like.

In some embodiments, the virtual workload 110 is connected to a storage disk, a plurality of storage disks, and the like, such as storage disks 112-1 through 112-N, where ‘N’ is an integer having a value of ‘2’ or greater. In some embodiments, the storage disk is provisioned as a virtual disk, as a block address on a block storage, and the like. For example, a block storage is a Simple Storage Service (S3@), according to an embodiment.

In an embodiment, a user account 120 includes unique identifiers, such as email address, username, password, combinations thereof, and the like. A user account is managed by an identity and access management (IAM) service in a cloud environment, according to an embodiment. The IAM service further controls (i.e., defines authorizations, policies, rules, and the like, for) user groups, user roles, permissions, service accounts, and the like, in some embodiments.

In some embodiments an inspector account 130 is deployed in the production environment 102, and is implemented, for example as a user account, a service account, and the like. The inspector account is authorized to communicate with various components of the cloud environment 102 and further communicate with an inspecting cloud environment 104, according to some embodiments.

In certain embodiments, the inspector account 130 is configured to communicate with a key management service (KMS) 140. The KMS 140 is implemented as a virtual workload, a plurality of virtual workloads, and the like, in the production cloud environment 102, according to an embodiment. In some embodiments the KMS 140 is deployed on the cloud computing infrastructure on which the production environment 102 is deployed.

A KMS 140 is configured to store therein keys which are used to access encrypted resources in the production cloud environment 102, such as encrypted disks, encrypted files, and the like, according to an embodiment. The KMS 140 further includes a security policy engine 142, which is configured to associate a security policy with at least a portion of the keys stored in the KMS 140, according to an embodiment. In certain embodiments, a security policy indicates what user accounts are authorized to use a key managed by the KMS 140.

In an embodiment, the inspecting cloud environment 104 is configured to receive information from the production cloud environment 102 and is further configured to detect cybersecurity risks in the production cloud environment 102. In some embodiments, the inspecting cloud environment 104 includes a plurality of inspectors, such as inspector 150, which are each configured to detect a cybersecurity object. A cybersecurity object is, according to an embodiment, a secret, an application, a key, a certificate, a malware, a password, a combination thereof, and the like.

In certain embodiments, the inspector 150 is implemented as a virtual workload, such as a serverless function, deployed in the inspecting cloud environment 104. An inspector 150 is configured to receive information originating from the cloud production environment 102, in some embodiments, and is further configured to inspect the information to discover predefined data objects (i.e., cybersecurity objects) therein.

In an embodiment, the inspecting cloud environment 104 further includes a software container cluster, such as software container cluster 160. The software container cluster 160 is implemented for example utilizing a Kubernetes® (stylized as K8s) application, according to an embodiment. In certain embodiments, each cluster 160 includes a plurality of nodes.

For example, in an embodiment, an inspectable disk is generated based on the disk 112-1 in order to inspect the contents of the disk 112-1. In an embodiment, the inspectable disk is generated based on a snapshot, a clone, a copy, a combination thereof, and the like, of the disk 112-1. In certain embodiments, access to the inspectable disk is provided to the inspector 150 via the inspector account 130. For example, the inspector 150 is configured, in an embodiment, to utilize a service account (e.g., the inspector account 130) to access the inspectable disk and perform operations thereon, such as a read operation to access the contents of the inspectable disk.

In an embodiment, the software container cluster 160 is configured to provision a storage resource attached to a container, for example as a volume which is generated based on the inspectable disk. In certain embodiments, an inspector 150 is configured to access to the volume, and inspect the volume for a cybersecurity object. In an embodiment a plurality of inspectors are configured to each access the volume generated from the inspectable disk. Inspecting the inspectable disk in place of the disk 112-1 in the production environment allows the production environment to continue its operation with minimal interference, while inspecting the contents of the disk 112-1 without disrupting operation in the production environment.

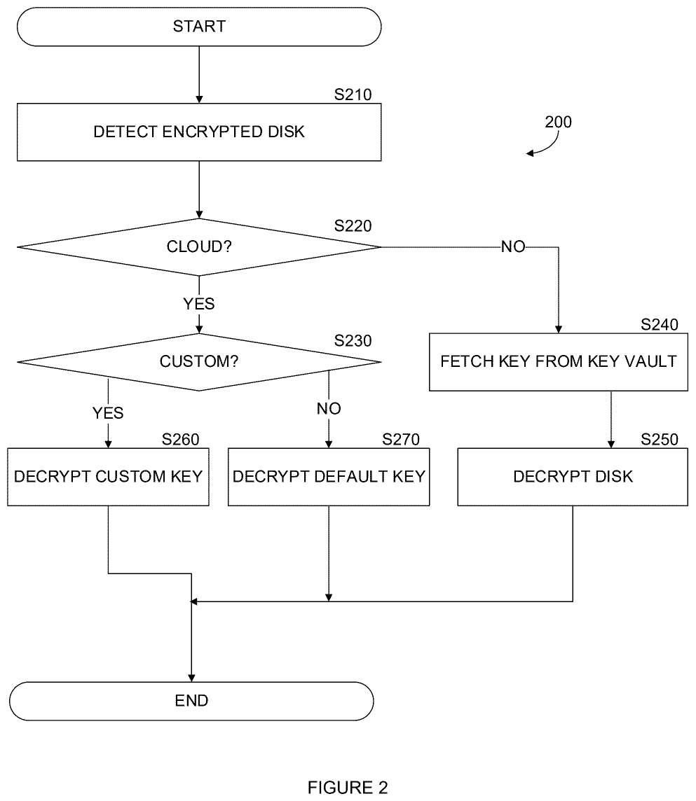

FIG. 2 is an example flowchart 200 of a method for inspecting encrypted disks of workloads in a cloud environment, implemented according to an embodiment. In some embodiments, generating an inspectable disk based on a snapshot of an encrypted disk will result in a snapshot which is not readable without a corresponding key.

It is beneficial for the inspecting cloud environment to be able to inspect such encrypted disks. In an embodiment, encryption of the disk is provided at the cloud level, application level, a combination thereof, and the like.

While some embodiments illustrate users of cloud managed encryption in AWS, and application level encryption in Azure, it should be readily apparent that the teachings herein can be applied to other cloud infrastructures with appropriate adjustments.

At S210, an encrypted disk is selected for inspection. In an embodiment, the encrypted disk is associated with a virtual workload, for example by provisioning a storage resource to the virtual workload. In an embodiment, a virtual workload is, for example, a virtual machine, a serverless function, a software container, and the like. In an embodiment, an inspection account (i.e., a service account) is utilized in determining that a disk is encrypted in a production cloud environment.

For example, in an embodiment a service account is authorized to access a disk, access metadata of a storage disk, access a storage provisioning system, and the like, to determine if a disk is an encrypted disk. In an embodiment, an encrypted disk includes metadata which indicates that the disk is an encrypted disk.

At S220, a check is performed to determine a level of encryption. In an embodiment, a disk is encrypted at application level, encrypted at cloud level, a combination thereof, and the like. In an embodiment, cloud level encryption (also referred to as cloud managed encryption) includes utilizing a key of a Key Management System (KMS) to encrypt a disk. In an embodiment, if the disk is encrypted at the application level execution continues at S230.

In some embodiments, if the disk is encrypted using cloud managed encryption execution continues at S240. In an embodiment, a disk may be encrypted utilizing one or more methods of cloud managed encryption and application level encryption. The methods for accessing such disks may be used consecutively, until a fully decrypted disk is accessible.

At S230, a check is performed to determine a key type. In an embodiment, a key type is a default key, a custom key, and the like. For example, a KMS in AWS supports two types of keys. The first type is an Elastic Block Store (EBS) default key, and the second type is a custom key. A policy associated with the default key cannot be changed, while for a custom key the policy can be configured, and reconfigured. If the key is a custom key execution continues at S260, according to an embodiment. In an embodiment, if the key is a default key, execution continues at S270.

At S240, a key is fetched from the key vault. For example, in an embodiment, Azure Key Vault is utilized as a KMS, implemented in Azure® cloud environments. At an application level encryption, a disk may be encrypted using Bitlocker (for Windows® operating systems), Cryptoluks (for Linux operating systems), and like, in some embodiments. An inspector account is authorized to fetch keys from a key vault, according to an embodiment. In certain embodiments, a key is a KEK (key encryption key), meaning that the key is encrypted using another asymmetric encryption, and this needs to be decrypted as well.

At S250, the disk is decrypted. In an embodiment the disk is decrypted using the key fetched from the key vault. In some embodiments, an inspectable disk is generated from the decrypted disk, and access thereto is provided to an inspecting cloud environment, where the inspectable disk is inspected for cybersecurity objects. In an embodiment, a disk is encrypted at application level utilizing based on the operating system, for example Microsoft® Windows, or Linux.

Linux disks utilize Cryptoluks, which, in an embodiment, contains two partitions, a first partition which is encrypted and a second partition which is plaintext. The plaintext partition is mounted in the inspecting cloud environment, according to an embodiment. In some embodiments, the plaintext partition includes a file named ‘osluksheader’ which appears in the ‘luks’ directory. In an embodiment, an inspector is configured to execute a decrypt command, for example:

sudo cryptsetup open/dev/<encrypted-device><name>-header=/<mountpoint>/luks/osluksheader
When prompted for a password, the passphrase (i.e., key) is provided after decoding the base64 through the pipe connected to the stdin. The result is a readable disk which is mountable using the device mapper, for example:
mount/dev/mapper/<name><mount point>
In an embodiment the disk is mounted, for example on a volume which is provisioned in an inspection cluster. In certain embodiments, an inspector is configured to search the disk for data objects (e.g., cybersecurity objects) which are utilized to assess security risks and map the disk, its contents, the corresponding workload, a combination thereof, and the like, to a security graph 170.

Windows operating system utilizes the Bitlocker application, according to an embodiment. Decrypting a Bitlocker encrypted disk includes, in an embodiment, setting the decoded base64 key from the keyvaults on the disk <secret-file.dat>. Decryption includes, according to an embodiment, executing the following command:

do dislocker/dev/<encrypted-device>-f<secret-file.bek>-/media/<unencrypted-device>
In an embodiment, initiating execution of the command is performed by the inspector account. A decrypted disk is mounted, according to an embodiment, by initiating execution of the following instruction:
mount/media/<unencrypted-device>/dislocker-file/<mount-point>
In an embodiment, the instruction is executed by a control plane of a software container cluster in an inspection environment. A mounted disk, for example on a volume which is provisioned in an inspection software container cluster, is inspected for cybersecurity objects. In some embodiments, the disk, its contents, any detected cybersecurity object, and a corresponding workload, are represented on a security graph 170.

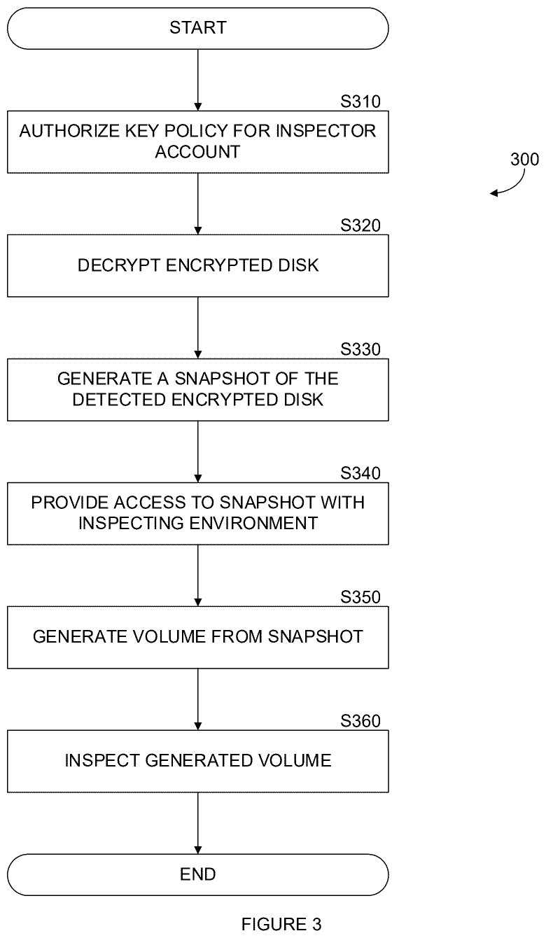

At S260, the disk is decrypted using the custom key. In some embodiments, decryption utilizing a custom key is described in more detail with respect to FIG. 3.

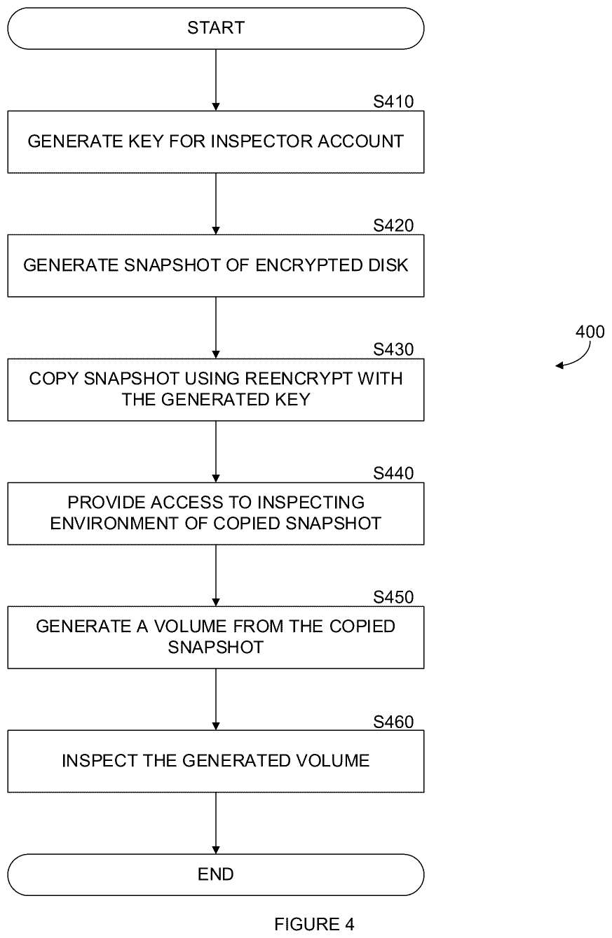

At S270, the disk is decrypted using the default key. Decryption utilizing a default key is described in more detail with respect to FIG. 4.

FIG. 3 is an example of a flowchart 300 of a method for disk decryption utilizing a custom key for inspecting a disk for a cybersecurity object, implemented in accordance with an embodiment.

At S310, a key policy is attached to a custom key. The custom key is used for decrypting an encrypted disk in a cloud computing environment. In an embodiment, AWS KMS is used in an AWS cloud environment. A kms: PutKeyPolicy instruction is set to provide cross-account permissions, allowing an inspector account access to the required decryption keys, according to an embodiment.

In certain embodiments, the KMS is configured to provide certain instructions (such as DecribeKey, CreateGrant, GenerateDataKey, ReEncrypt, Decrypt, etc.) only to keys in the KMS which have a tag corresponding to permissions granted to the inspector account.

At S320, the encrypted disk is decrypted. In an embodiment, the decrypted disk is utilized in generating an inspectable disk. In some embodiments, the encrypted disk is decrypted by executing an instruction initiated by an inspector account utilizing the decryption key accessed from the KMS, access to which was previously provided to the inspector account.

At S330, an inspectable disk is generated based on the decrypted disk. In certain embodiments, generating an inspectable disk includes generating a clone, a copy, a snapshot, and the like, based on the decrypted disk. In an embodiment the instruction for generating the inspectable disk is initiated by the inspector account.

At S340, access to the inspectable disk is provided to an inspector. In an embodiment, providing access to an inspector includes providing access to the inspectable disk to a service account (e.g., inspector account) which is configured to be assumed by an inspector workload.

In an embodiment, providing access includes sending a copy, a pointer of a clone, a snapshot, and the like, from the inspector account to the inspecting environment over a secure communication channel, such as a secure shell (SSH) communication.

At S350, a volume is generated from the inspectable disk. In an embodiment, a software container cluster is configured to provision a storage, into which a volume is generated based on the inspectable disk.

At S360, an instruction is generated to inspect the volume. In an embodiment, the volume is inspected for cybersecurity objects. In some embodiments, inspection includes searching the volume for files, text, regular expressions (regex), secrets, keys, application identifiers, malware signatures, virtual workloads, misconfigurations, combinations thereof, and the like.

FIG. 4 is an example flowchart 400 of a method for disk decryption utilizing a default key for detecting cybersecurity objects, implemented in accordance with an embodiment. In certain cloud infrastructures, such as AWS, default keys do not support changing of an attached security policy.

At S410, a key is generated for an inspector account. In an embodiment, the key is generated to allow cross account access, with permissions for the inspector account. For example, an encrypted disk is selected, and a key is generated for the inspector account, to allow the inspector account to access the encrypted disk, according to an embodiment. In some embodiments, the inspector account is a service account which is configured to be assumed by an inspector workload.

At S420, a snapshot is generated of the encrypted disk. In an embodiment, generating the snapshot is performed based on executing an instruction initiated by an inspector account. In certain embodiments, the snapshot is a block-based copy of the encrypted disk at a particular point in time.

At S430, the snapshot is copied with a reencrypt command. Copying a snapshot includes, in an embodiment, executing a CopySnapshot instruction with a ReEncrypt instruction, where reencryption is performed with the generated key. In an embodiment, the instructions are provided by the inspector account, which has kms: CreateGrant and kms: ReEncryptFrom permissions from the KMS.

At S440, access is provided to the copied snapshot. In an embodiment, access is provided to an inspecting cloud environment, such as the inspecting cloud environment 104 of FIG. 1 above, and specifically to an inspector, for example by providing authorization to an inspector account to access the copied snapshot. In an embodiment, the copied snapshot is decrypted using the generated key for the inspector account. The key is provided to the inspector account. according to some embodiments.

At S450, a volume is generated from the copied snapshot. In an embodiment, a software container cluster is configured to provision a storage space, into which a volume is generated based on the copied snapshot of the decrypted disk.

At S460, the generated volume is inspected for a cybersecurity object. In an embodiment, inspection includes searching the volume for a file, a text, a regular expression (regex), a secret, a key, a certificate, a virtual workload, a combination thereof, and the like.

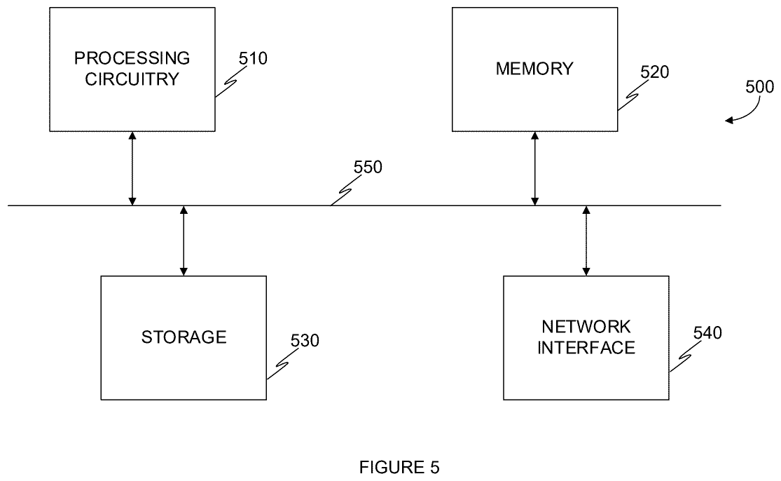

FIG. 5 is an example schematic diagram of a system configured to execute an inspector 150 according to an embodiment. The inspector 150 is a virtual workload, such as a container, to which hardware is provisioned in order to execute the instructions contained therein. The system 500 includes a processing circuitry 510 coupled to a memory 520, a storage 530, and a network interface 540. In an embodiment, the components of the system 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, or any other medium which can be used to store the desired information.

The network interface 540 allows the system 500 to communicate with, for example, the inspector account 130.

It should be understood that the embodiments described herein are not limited to the specific architecture illustrated in FIG. 5, and other architectures may be equally used without departing from the scope of the disclosed embodiments.

It should be understood that the embodiments described herein are not limited to the specific architecture illustrated in in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for inspecting encrypted disks for a cybersecurity object using a custom key, comprising:
detecting an encrypted disk associated with a workload in a cloud computing environment, the cloud computing environment including a security policy server;
authorizing a key policy for decrypting the encrypted disk on the security policy server for a custom key associated with an inspector account;
decrypting the encrypted disk with the custom key by the inspector account; and
generating an inspectable disk based on the decrypted encrypted disk.

2. The method of claim 1, further comprising:
inspecting the inspectable disk to detect a cybersecurity object.

3. The method of claim 2, further comprising:
generating the inspectable disk based on a clone of the decrypted encrypted disk.

4. The method of claim 2, further comprising:
generating the inspectable disk based on a snapshot of the decrypted encrypted disk.

5. The method of claim 2, further comprising:
generating the inspectable disk based on a copy of the decrypted encrypted disk.

6. The method of claim 1, further comprising:
determining that the encrypted disk utilizes an application based encryption; and
fetching the custom key from a key vault management system.

7. The method of claim 1, further comprising:
decrypting the custom key, wherein the custom key is encrypted using a key-encryption-key.

8. The method of claim 1, further comprising:
setting a decoded base64 key from a key vault on the encrypted disk, in response to determining that an operating system of the workload utilizes Bitlocker.

9. The method of claim 1, further comprising:
determining that the encrypted disk is encrypted based on metadata associated with the encrypted disk.

10. A non-transitory computer-readable medium storing a set of instructions for inspecting encrypted disks for a cybersecurity object using a custom key, the set of instructions comprising:
one or more instructions that, when executed by one or more processing circuitries of a device, cause the device to:
detect an encrypted disk associated with a workload in a cloud computing environment, the cloud computing environment including a security policy server;
authorize a key policy for decrypting the encrypted disk on the security policy server for a custom key associated with an inspector account;
decrypt the encrypted disk with the custom key by the inspector account; and
generate an inspectable disk based on the decrypted encrypted disk.

11. A system for inspecting encrypted disks for a cybersecurity object using a custom key comprising:
one or more processing circuitries configured to:
detect an encrypted disk associated with a workload in a cloud computing environment, the cloud computing environment including a security policy server;
authorize a key policy for decrypting the encrypted disk on the security policy server for a custom key associated with an inspector account;
decrypt the encrypted disk with the custom key by the inspector account; and
generate an inspectable disk based on the decrypted encrypted disk.

12. The system of claim 11, wherein the one or more processing circuitries are further configured to:
inspect the inspectable disk to detect a cybersecurity object.

13. The system of claim 12, wherein the one or more processing circuitries are further configured to:
generate the inspectable disk based on a clone of the decrypted encrypted disk.

14. The system of claim 12, wherein the one or more processing circuitries are further configured to:
generate the inspectable disk based on a snapshot of the decrypted encrypted disk.

15. The system of claim 12, wherein the one or more processing circuitries are further configured to:
generate the inspectable disk based on a copy of the decrypted encrypted disk.

16. The system of claim 11, wherein the one or more processing circuitries are further configured to:
determine that the encrypted disk utilizes an application based encryption; and
fetch the custom key from a key vault management system.

17. The system of claim 11, wherein the one or more processing circuitries are further configured to:
decrypt the custom key, wherein the custom key is encrypted using a key-encryption-key.

18. The system of claim 11, wherein the one or more processing circuitries are further configured to:
set a decoded base64 key from a key vault on the encrypted disk, in response to determining that an operating system of the workload utilizes Bitlocker.

19. The system of claim 11, wherein the one or more processing circuitries are further configured to:
determine that the encrypted disk is encrypted based on metadata associated with the encrypted disk.
